(19) United States
(12) Patent Application Publication
(10) Pub. No.: US 2016/0367064 A1
(43) Pub. Date: Dec. 22, 2016

(54) REUSABLE FILTER CARTRIDGE FOR MULTIPLE BREWER TYPES

(71) Applicant: Eko Brands, LLC, Woodinville, WA (US)

(72) Inventor: Ronald R. DeMiglio, Snohomish, WA (US)

(21) Appl. No.: 15/189,731

(22) Filed: Jun. 22, 2016

Related U.S. Application Data
(63) Continuation-in-part of application No. 15/061,082, filed on Mar. 4, 2016.
(60) Provisional application No. 62/182,879, filed on Jun. 22, 2015.

(51) Int. Cl. A47J 31/06

(52) U.S. Cl. CPC A47J 31/06

(57) ABSTRACT

A brewing device includes a base cup having a sidewall defining a plurality of openings that are covered with a filtering material. A bottom wall defines impermeable outlet probe receptacles sized and positioned to receive an outlet probe of a brewing device. Two or more adapter rings removably secure to the base cup thereby defining multiple combinations with differing volumes for use in different brewing devices and for preparing different numbers of servings. An adapter ring for multiple-serving implementations may include a tube along the side thereof with a bottom opening located below the lowermost surface of the adapter ring. An insert secures within each adapter ring and defines an inlet probe aperture and structures for creating a seal with respect to an inlet probe of a brewing device. In one embodiment, an adapter ring and the base cup are sonically welded together having a screen positioned therebetween.

### PRIORITY CLAIM

This application is a continuation-in-part of U.S. application Ser. No. 15/061082, filed Mar. 4, 2016, and claims priority from U.S. Provisional Patent Application No. 62/182,879, filed Jun. 22, 2015, entitled BEVERAGE BREWING DEVICE, the contents of which are hereby incorporated by reference.

### FIELD OF THE INVENTION

This application relates to cartridges for holding a brewing medium for use with an automated beverage brewer.

### BACKGROUND OF THE INVENTION

There are numerous devices available today for making a single-serve brewed beverage, such as the single-server brewers shown and described in, for example, U.S. Pat. Nos. 6,708,600, and 6,079,315, the disclosures of which are hereby expressly incorporated by reference herein.

In a typical single-serve beverage brewer, a disposable beverage filter cartridge containing a dry beverage medium (such as tea or coffee) is disposed within a filter cartridge holder or brewing holster. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

By requiring the use of the disposable cartridges, the consumer is limited to the beverage selection of the cartridges on hand. Moreover, with each cartridge being disposed of after use, there is much needless waste. Thus there is a need for a reusable cartridge filter suitable for use with a beverage brewer described above that can be used with any desired dry beverage medium (coffee, tea, etc.).

The apparatus and methods disclosed herein provide an improved approach for preparing brewed beverages using a beverage brewer designed to use disposable cartridges.

### SUMMARY OF THE INVENTION

In one aspect of the invention a method for manufacturing a cup includes providing a base cup defining a bottom and a base sidewall extending upwardly from the bottom. The method further includes providing a first ring cup defining a first sidewall and an upper tube extending along an outer surface of the upper sidewall, the upper tube defining an upper opening and a lower opening.

The method includes fastening the base cup to the first ring together and fastening a screen to at least one of the base cup and the first ring such that only fluid draining through the screen will be incident on the lower opening when the base cup, first ring, and screen are used in a brewing machine.

In some embodiments, securing the screen to the at least one of the base cup and the first ring comprises capturing the screen between the base cup and the first ring.

In some embodiments, the base cup further comprises a lower tube portion projecting outwardly from an inner surface of the base sidewall, the lower tube portion defining a channel aligned with the lower opening.

In some embodiments, fastening the base cup to the first ring comprises sonically welding the base cup to the upper cup.

In some embodiments, the base cup defines an outlet probe receptacle protruding inwardly from the bottom. In such embodiments, the method may further include (a) placing a first quantity of a brewing substance in the first ring and base cup; (b) securing a first lid to the first ring, the first lid defining a first inlet probe aperture; (c) inserting the first ring and base cup into a first cavity of a first beverage brewer; (d) inserting a first inlet probe of the first beverage brewer into the first inlet probe aperture; (e) brewing a first beverage by inputting liquid through the first inlet probe and drawing liquid out through the first outlet probe; (f) removing the base cup from the first ring; (g) removably fastening the base cup to a second ring, the second ring extending upwardly from the base cup a different extent than the first ring; (h) placing a second quantity of the brewing substance in the second ring and base cup; (i) securing a second lid to the second ring, the second ring defining a second inlet probe aperture; (j) inserting the second ring and base cup into a second cavity of a second beverage brewer, the second beverage brewer including a second outlet probe and having a second outlet probe of the second coffee maker projecting into the outlet probe receptacle; (k) inserting a second inlet probe of the second beverage brewer into the second inlet probe aperture; and (l) brewing a second beverage by inputting liquid through the second inlet probe and drawing liquid out through a second outlet probe.

In some embodiments, the second ring extends upwardly from the base cup a smaller extent than the first ring.

In some embodiments, the second ring and base cup when fastened to one another define a volume sized for brewing of a single serving; and

In some embodiments, the first ring and base cup when fastened to one another define a volume sized for brewing three or more servings.

In some embodiments, the method further includes inserting the first outlet probe into the upper opening.

In some embodiments, the upper tube extends downwardly beyond a lowermost edge of the first ring.

In some embodiments, the tube defines a bottom opening, the bottom opening positioned outside of an interior volume defined by the base cup and second ring.

In some embodiments, the base cup includes base threads, the first ring includes first threads, and the second ring includes second threads.

In some embodiments, fastening the first ring to the base cup comprises engaging the base threads with the first threads.

In some embodiments, fastening the second ring to the base cup comprises engaging the base threads with the second threads.

In some embodiments, the outlet probe receptacle is a first outlet probe receptacle, the base cup further defining a second outlet probe receptacle, the first and second outlet probe receptacles being 180 degrees apart.

In some embodiments, the outlet probe receptacle defines a continuous imperforated surface.

In some embodiments, the first lid further comprises a resilient material and defines a recess on an upper surface of the first lid surrounding the first inlet probe aperture, the recess sized to receive a shoulder surrounding the first inlet probe.

### BRIEF DESCRIPTION OF THE DRAWINGS

Preferred and alternative examples of the present invention are described in detail below with reference to the following drawings:

FIGS. 1A and 1B are isometric cut-away views of a base cup in accordance with an embodiment of the present invention;

FIG. 2 is an isometric view of a first adapter ring for securing to the base cup in accordance with an embodiment of the present invention;

FIG. 3 is an isometric view of an inlet probe insert for securing to the first adapter ring in accordance with an embodiment of the present invention;

FIG. 4 is a side cross-sectional view of the base cup having the first adapter ring secured thereto positioned within a beverage brewer in accordance with an embodiment of the present invention;

FIG. 5 is an isometric view of a second adapter ring for securing to the base cup in accordance with an embodiment of the present invention;

FIG. 6 is an isometric view of an inlet probe insert for securing to the second adapter ring in accordance with an embodiment of the present invention;

FIG. 7 is a side cross-sectional view of the base cup having the second adapter ring secured thereto positioned within a different beverage brewer in accordance with an embodiment of the present invention;

FIG. 8 is a side view of another embodiment of a brewing cup in accordance with an embodiment of the present invention;

FIG. 9 is a front view of the embodiment of FIG. 8;

FIG. 10 is an isometric view of the embodiment of FIG. 8; and

FIG. 11 is a side cross-sectional view of the embodiment of FIG. 8.

### DETAILED DESCRIPTION OF THE PREFERRED EMBODIMENT

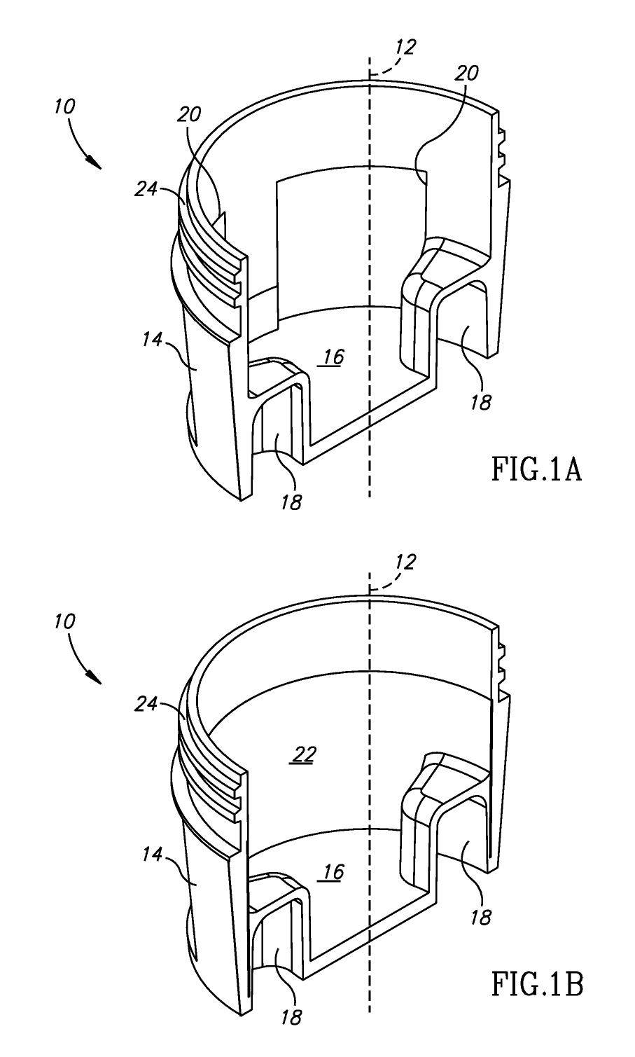

Referring to FIG. 1A, a base cup 10 may be used in combination with one or more adapter rings in order to provide a reusable filter cartridge that can be used with multiple beverage brewers to prepare varying quantities of a brewed beverage.

The base cup 10 may define an axis of symmetry 12 about which a sidewall 14 of the base cup 10 is generally symmetrical with various non-symmetrical features defined thereon. The sidewall 14 has a generally conical shape with a shallow tapering to conform to a cavity of a beverage brewer. A bottom wall 16 extends inwardly from the sidewall 14 such that some or all of the sidewall 14 extends above an upper surface of the bottom wall 16. One or more outlet probe receptacles 18 protrude inwardly from one or both of the sidewall 14 and the bottom wall 16. In the illustrated embodiment, two outlet probe receptacles 18 protrude upwardly through the bottom wall 16 and are disposed 180 degrees apart about the axis of symmetry 12. The outlet probe receptacles 18 include pockets made of continuous, imperforated, impermeable material (e.g., the same material as the base cup) that isolate the contents of the base cup 10 from an outlet probe protruding into the outlet probe receptacle. In a typical beverage brewer, only one outlet probe is present. However, providing two receptacles 18 enables the user to position the base cup in two positions without interference from the outlet probe.

The sidewall 14 further defines one or more filter apertures 20. The filter apertures 20 may be large and occupy a major portion (e.g., between 50 and 80 percent) of the vertical (e.g., parallel to the axis of symmetry 12) and circumferential (e.g., about the axis of symmetry 12) extent of the sidewall 14 between the topmost and bottommost edges thereof.

Referring to FIG. 1B, the filter apertures 20 are completely covered by filter material 22. Any suitable reusable, durable filter may be used, such as a micro-screen mesh filter made from metal (such as gold or stainless steel, gold-tone filters), plastic, or fabric. The filter material 22 may be molded into the material of the sidewall 14 in order to resist separation from the sidewall 14 after repeated use.

An upper rim of the sidewall 14 includes a fastening structure such as threads 24, a snap-type fitting, or any other type of fastening structure. The filter apertures 20 are positioned between the threads 24 and the bottom wall 16 such that a seal may be created between the threads 24 and an adapter ring secured thereto.

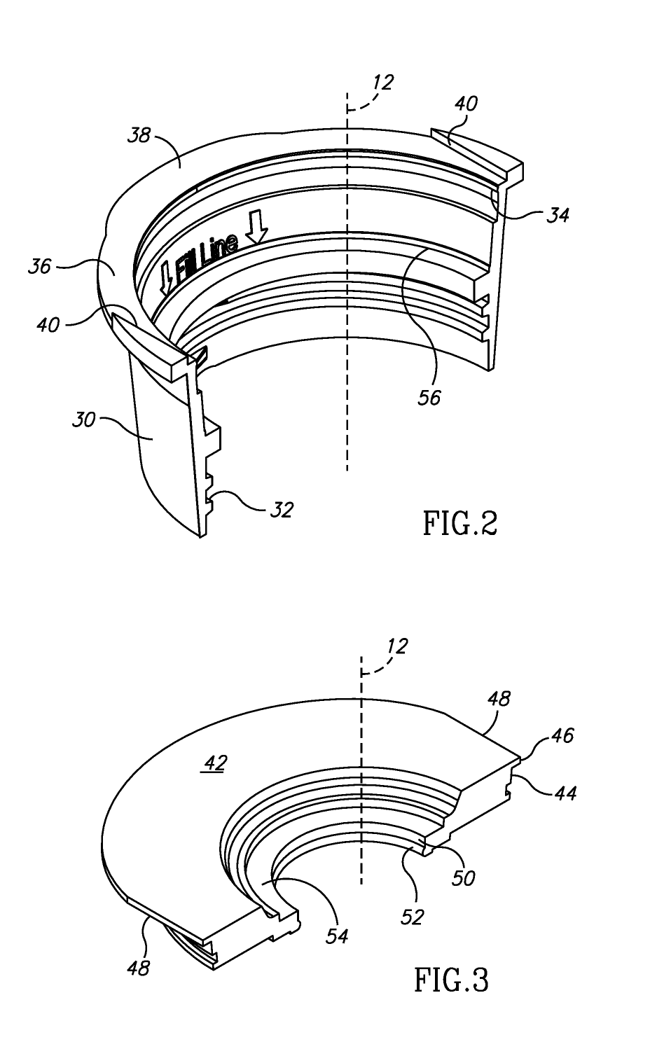

Referring to FIG. 2, an adapter ring 30 may fasten to the base cup 10 such that together they form a cup sized to fit within a cavity of a beverage brewer that is sized to receive a particular type of disposable cartridge. In the illustrated embodiment, the adapter ring 30 is a continuous impermeable ring without apertures covered in filtering material. In some embodiments, openings covered in filtering material may be included in the adapter ring 30. The adapter ring 30 may have a generally conical shape having a taper matching that of the sidewall 14 of the base cup 10 or being different therefrom. The adapter ring 30 includes fastening structures at its lower rim for securing to the base cup 10. In the illustrated embodiment, threads 32 are defined on an inner surface of the adapter ring 30 and are sized to engaged the threads 24 of the base cup 10 and create a seal.

An inner rim 34 may be defined on the ring 30 offset from the threads 32 along the axis of symmetry 12. The rim 34 may include threads or a continuous ridge or groove for receiving an insert (see FIG. 3). An outer rim 36 may protrude outwardly from, or near, the upper edge of the ring 30, the upper edge of the ring 30 being the edge furthest from the threads 32 along the axis of symmetry 12. The outer rim 36 may be sized to seat within a seating groove of a beverage brewer as described below. The outer rim 36 may include one or more tabs 38 that project outwardly form the remaining portions of the rim 36 in order to facilitate alignment. For example, the tabs 38 may be aligned with the outlet probe receptacles of the base cup 10 when the base cup 10 is fastened to the adapter ring 30. The outer rim 36 may define flattened, inward-facing shoulders 40 that project upwardly from the rim 36 parallel to the axis of symmetry 12.

Referring to FIG. 3, an insert 42 is positioned within the upper portion of the adapter ring 30 and defines a circumferential surface 44 sized to engage with the inner rim 34 of the adapter ring 30 thereby creating a seal. The insert 42 may be formed of a resilient polymer such that it may deform to permit insertion into the inner rim 34. The insert 42 may include an outer rim 46 that projects outwardly from the surface 44 and rests on an upward facing surface (e.g., facing parallel to the axis of symmetry 12) of the adapter ring 30 when engaged with the groove 44 is engaged with the inner rim 34. The outer rim 46 may be circular about the axis of symmetry 12 except for flattened 48 portions that are sized and positioned to engage with the shoulders 44 when the groove 44 is engaged with the inner rim 34.

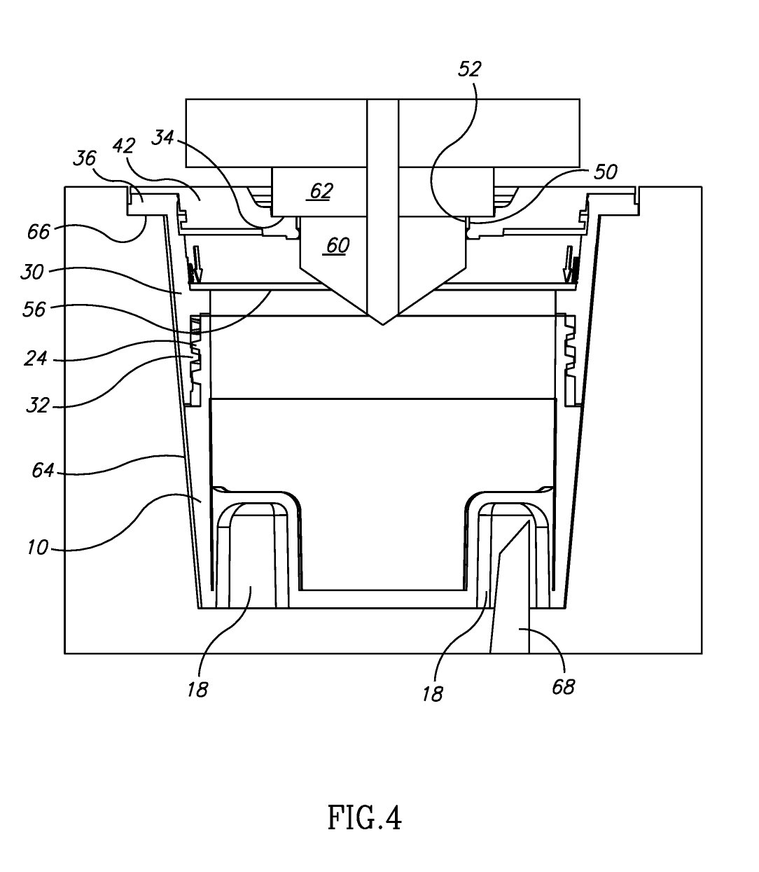

The insert 42 further defines an inlet probe aperture 50 sized to receive an inlet probe of a beverage brewer. The insert 42 may include a sealing ring 52 projecting inwardly into the inlet probe aperture 50 in order to create a seal between itself and the inlet probe. Accordingly, the inner diameter of the sealing ring 52 may be smaller than that of the inlet probe such that elastic deformation of the sealing ring 52 is required to insert the inlet probe. An upper surface of the insert 42 may further include a recessed seat 54 surrounding the inlet probe aperture 50 and providing a surface for engaging a shoulder surrounding the inlet probe of a beverage brewer in order to create a seal. The spacer ring 30 may include a line, text, circumferential rib, or other structure 56 (see FIG. 4) instructing a user as to the proper fill level. The level of the brewing medium within the spacer ring 30 and base cup 10 combination is preferably such that it does not contact the inlet probe of a beverage brewer when inserted within the inlet probe aperture 50 or otherwise is appropriate for the amount of a beverage to be brewed.

FIG. 4 illustrates the base cup 10 secured to the adapter ring 30 and having the insert 42 engaged with the inner rim 34 of the adapter ring 30. FIG. 4 further shows an inlet probe 60 inserted within the inlet probe aperture 50. A shoulder 62 or seal 62 made of a flexible polymer material surrounds the inlet probe 60 and engages the recessed seat 54 thereby promoting a seal. Likewise, the sealing ring 52 contacts the inlet probe and further promotes sealing.

The base cup 10 and the adapter ring 30 are secured to one another by means of the engagement of the threads 24 of the base cup 10 with the threads 32 of the adapter ring 30. The base cup 10 and some or all of the adapter ring 30 sit within a cavity 64 having a size and shape conforming to the size and shape of the base cup 10 and any portion of the adapter ring 30 positioned therein. The cavity 64 may include a rim seat 66 that is sized to receive the outer rim 36 of the adapter ring 30, such as a countersunk portion 66 of a conical-shaped cavity 64 sized to receive the base cup 10 and adapter ring 30.

An outlet probe 68 protrudes into the cavity from a lower surface thereof and is positioned within one of the outlet probe receptacles 18. In a typical beverage brewer, there is a single outlet probe 68. Accordingly, the base cup may be rotated 180 degrees and still provide clearance for the outlet probe 68 in embodiments having two outlet probe receptacles 18.

The base cup 10 and at least a portion of the volume within the spacer ring 30 is filled with a brewing medium such as coffee, tea, cocoa, or any other herb or substance that may be used to infuse water. In use, the amount of the brewing medium does not rise above the fill indicating structure 56, such as the “Fill Line” shown in FIG. 3.

After the base cup 10 and spacer ring 30 combination is placed in the cavity 64 and the inlet probe 60 and shoulder 62 are engaged with the insert 42 as shown in FIG. 4, hot water is dispensed through the inlet probe 60, passes through the brewing medium, passes out through the filter material 22, and is drawn out through the outlet probe 68. The beverage brewer then directs the water drawn into the outlet probe 68 into a cup or carafe in the conventional manner.

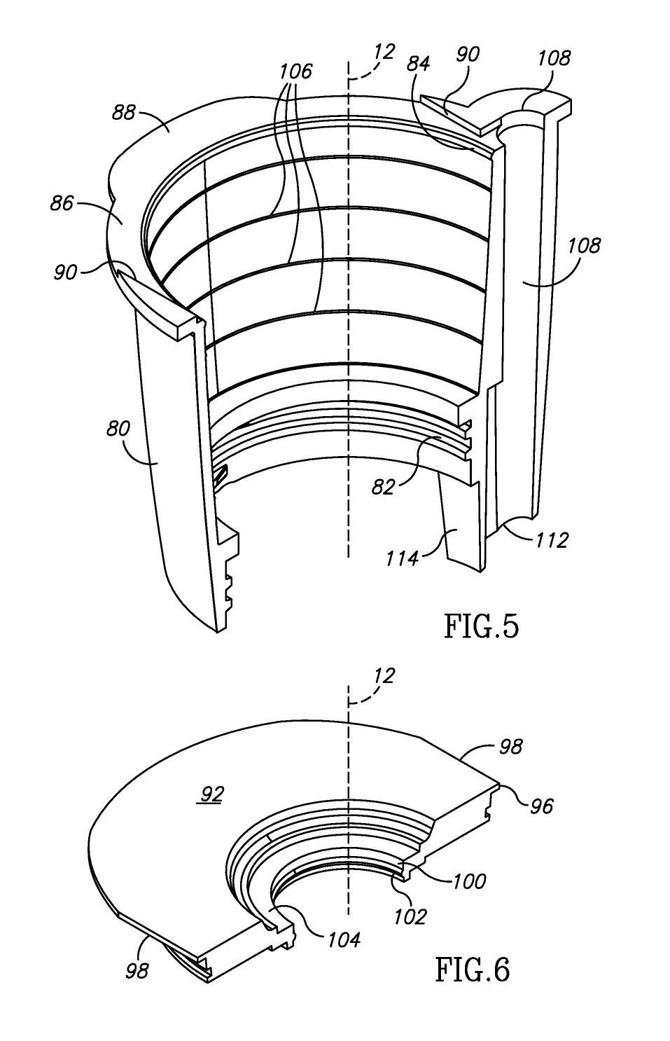

Referring to FIG. 5, an adapter ring 80 may fasten to the base cup 10 such that together they form a cup sized to fit within a cavity of a beverage brewer that is sized to receive a particular type of disposable cartridge. In the illustrated embodiment, the adapter ring 80 is a continuous impermeable ring without apertures covered in filtering material. In some embodiments, openings covered in filtering material may be included in the adapter ring 80. The adapter ring 80 may have a generally conical shape having a taper matching that of the sidewall 14 of the base cup 10 or being different therefrom. As is apparent in FIG. 5, the adapter ring 80 has a much greater extent parallel to the axis of symmetry 12 and is suitable for brewing multiple servings of a brewed beverage using a beverage brewer having a cavity sized to receive a much larger cartridge than the adapter 30 and base cup 10 combination. The adapter ring 80 includes fastening structures at its lower rim for securing to the base cup 10. In particular, the adapter ring 80 includes fastening structures to secure to the exact same base cup 10 as can secure to the adapter ring 30 as described above. In the illustrated embodiment, threads 82 are defined on an inner surface of the adapter ring 80 and are sized to engaged the threads 24 of the base cup 10 and create a seal.

An inner rim 84 may be defined on the ring 80 offset from the threads 82 along the axis of symmetry 12. The rim 84 may include threads or a continuous ridge or groove for receiving an insert (see FIG. 6). An outer rim 86 may protrude outwardly from, or near, the upper edge of the ring 80, the upper edge of the ring 80 being the edge furthest from the threads 82 along the axis of symmetry 12. The outer rim 86 may be sized to seat within a seating groove of a beverage brewer as described below. The outer rim 86 may include one or more tabs 88 that project outwardly form the remaining portions of the rim 86 in order to facilitate alignment. The outer rim 86 may define flattened, inward-facing shoulders 90 that project upwardly from the rim 86 parallel to the axis of symmetry 12.

Referring to FIG. 6, an insert 92 is positioned within the upper portion of the adapter ring 80 and defines a circumferential surface 94 sized to engage with the inner rim 84 of the adapter ring 80 thereby creating a seal. The insert 92 may be identical to the insert 42 or may be different. For example, the insert 92 may have a larger diameter but otherwise have the same structural features as the insert 42.

The insert 92 may be formed of a resilient polymer such that it may deform to permit insertion into the inner rim 84. The insert 92 may include an outer rim 96 that projects outwardly from the surface 94 and rests on an upward facing surface (e.g., facing parallel to the axis of symmetry 12) of the adapter ring 80 when engaged with the groove 44 is engaged with the inner rim 84. The outer rim 96 may be circular about the axis of symmetry 12 except for flattened portions 98 that are sized and positioned to engage with the shoulders 90 when the groove 94 is engaged with the inner rim 84.

The insert 92 further defines an inlet probe aperture 100 sized to receive an inlet probe of a beverage brewer. The insert 92 may include a sealing ring 102 projecting inwardly into the inlet probe aperture 100 in order to create a seal between itself and the inlet probe. Accordingly, the inner diameter of the sealing ring 102 may be smaller than that of the inlet probe such that elastic deformation of the sealing ring 102 is required to insert the inlet probe. An upper surface of the insert 92 may further include a recessed seat 104 surrounding the inlet probe aperture 100 and providing a surface for engaging a shoulder surrounding the inlet probe of a beverage brewer in order to create a seal.

Referring again to FIG. 5, the spacer ring 80 may include one or more a lines, ribs, or other structures 106 instructing a user as to the proper fill level. Inasmuch as the combined spacer ring 80 and base cup 10 enable the preparation of multiple servings, various lines 106 may be provided within the ring 80 each corresponding to a different number of servings. The level of the brewing medium within the spacer ring 80 and base cup 10 combination is preferably such that it does not contact the inlet probe inserted through the inlet probe opening 100 of a beverage brewer or otherwise is appropriate for the amount of a beverage to be brewed.

The spacer ring 80 may be different from the spacer ring 30 in that a tube 108 extends along the outer surface of the spacer ring 80. The tube 108 may be monolithically formed (e.g., co-molded) with the spacer ring 80 or secured thereto. An upper opening 110 of the tube 108 may be flush with an upper edge of the shoulders 90 and may be 90 degrees offset from the tabs 88 about the axis of symmetry 12.

A lower opening 112 of the tube 108 may be positioned at or below the lowermost edge of the spacer ring 80. In the illustrated embodiment, an extension 114 extends below the lower edge of the spacer ring 80 and the lower opening 112 is defined by a lowermost surface of the extension 114. As is apparent in FIG. 5, the cross-section of the tube 108 within the extension 114 (perpendicular to the axis of symmetry 12) changes above the lowermost edge of the spacer ring 80 down to the lower opening 112 of the tube 108. In particular, the cross-section becomes larger due to increased space between the tube and the inner wall of the spacer ring 80 due to the tapered shape of the spacer ring. In this manner, resistance to fluid flow is reduced.

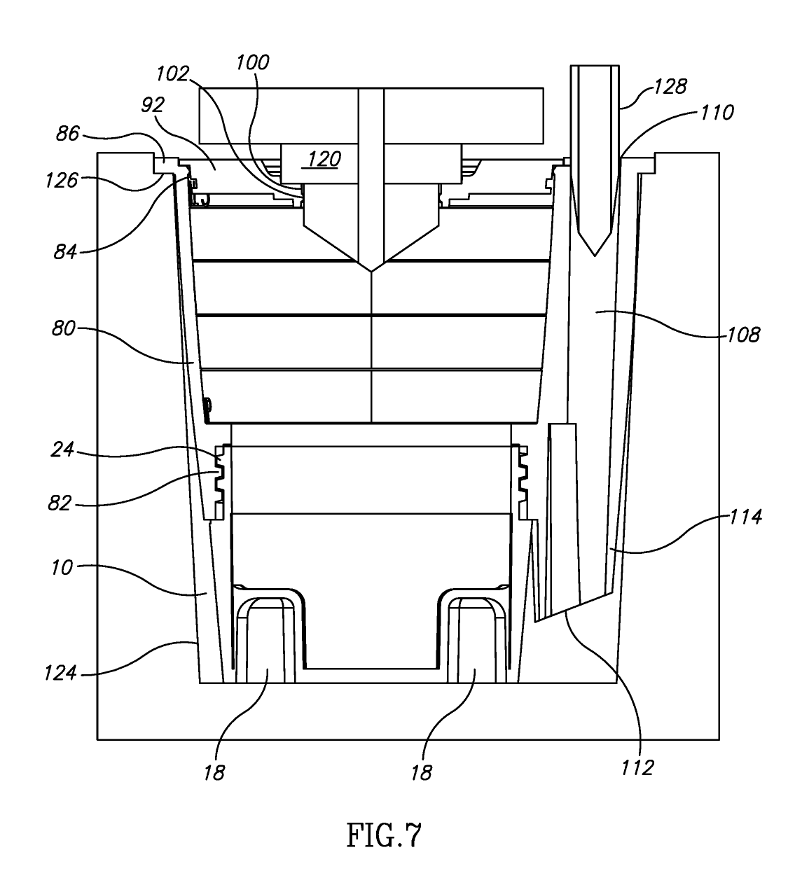

FIG. 7 illustrates the base cup 10 secured to the adapter ring 80 and having the insert 92 engaged with the inner rim 84 of the adapter ring 80. FIG. 7 further shows an inlet probe 120 inserted within the inlet probe aperture 100. A shoulder 122 or seal 122 made of a flexible polymer material surrounds the inlet probe 120 and engages the recessed seat 104 thereby promoting a seal. Likewise, the sealing ring 102 contacts the inlet probe 120 and further promotes sealing.

The base cup 10 and the adapter ring 80 are secured to one another by means of the engagement of the threads 24 of the base cup 10 with the threads 82 of the adapter ring 80. The base cup 10 and some or all of the adapter ring 80 sit within a cavity 124 having a size and shape conforming to the size and shape of the base cup 10 and any portion of the adapter ring 80 positioned in the cavity 124. The cavity 124 may include a rim seat 126 that is sized to receive the outer rim 86 of the adapter ring 80, such as a countersunk portion 126 of a conical-shaped cavity 124 sized to receive the base cup 10 and adapter ring 80.

An outlet probe 128 protrudes downwardly from above the cavity 124 and is positioned relative to the inlet probe 120 such that the outlet probe 128 extends into the upper opening 110 of the tube 108 when the inlet probe 120 is positioned within the inlet probe aperture 100 of the insert 92. Note that the outlet probe 128 does not extend into either outlet probe receptacle 18, which are not of use with the type of beverage brewer shown in FIG. 7.

The base cup 10 and at least a portion of the volume within the spacer ring 80 is filled with a brewing medium such as coffee, tea, cocoa, or any other herb or substance that may be used to infuse water. After the base cup 10 and spacer ring 80 combination is placed in the cavity 124 and the inlet probe 120 and shoulder 122 are engaged with the insert 92 and the outlet probe 128 is inserted within the tube 108 as shown in FIG. 7, hot water is dispensed through the inlet probe 120, passes through the brewing medium, passes out through the filter material 22, and is drawn out through the outlet probe 128. The beverage brewer then directs the water drawn into the outlet probe 128 into a cup or carafe in the conventional manner. In the illustrated embodiment, a seal may exist between the walls of the spacer ring 80 and/or base cup 10 and the walls of the cavity 124 such that suction applied through the tube 108 may draw liquid out of the cavity 124, rather than simply drawing in ambient air. Additionally or alternatively, the cavity 124 itself may be sealed by a cover included in the beverage brewer such that suction applied through the tube 108 will be effective to draw infused liquid within the cavity 124 notwithstanding the fact that the bottom opening 112 is not at the bottom of the cavity or connected to the volume enclosed by the base cup 10.

In use, the base cup 10 and spacer rings 30, 80 may be sold and stored as a kit. A user may then secure one spacer ring 30, 80 to the base cup 10, use it as described above to brew a beverage. The user may then secure the other spacer ring 80, 30 to the base cup 10 and use it as described above. A single product is therefore able to hold a brewing medium and perform filtering for multiple types of beverage brewers and for single serve use as well as multiple serving use. Although only two spacer rings 30, 80 are disclosed herein, other numbers and configurations of spacer rings 30, 80 may be used to accommodate still more types of beverage brewers.

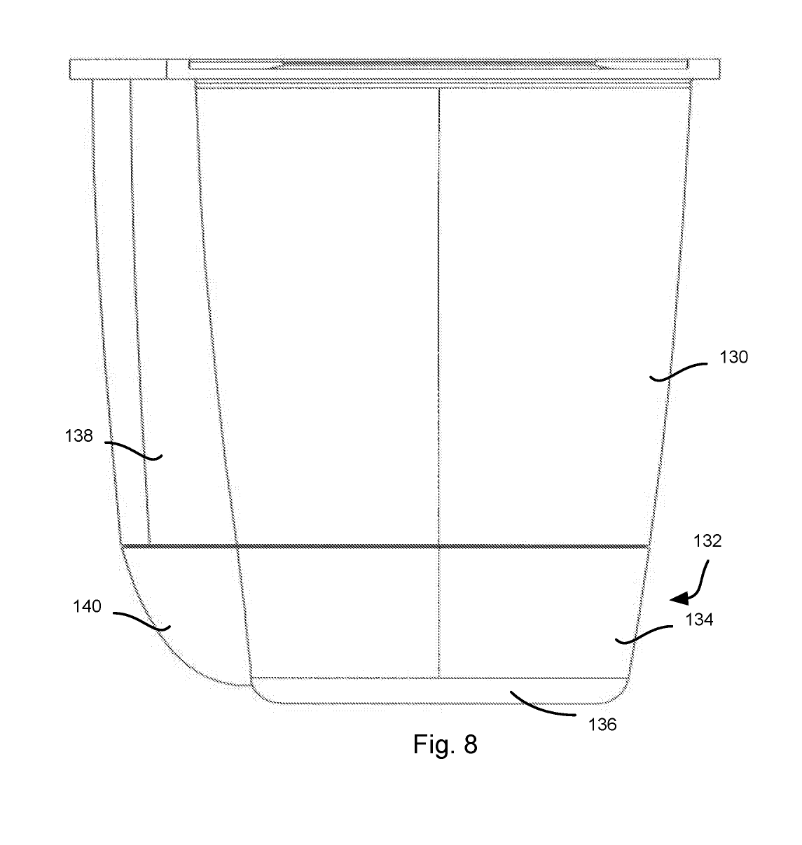

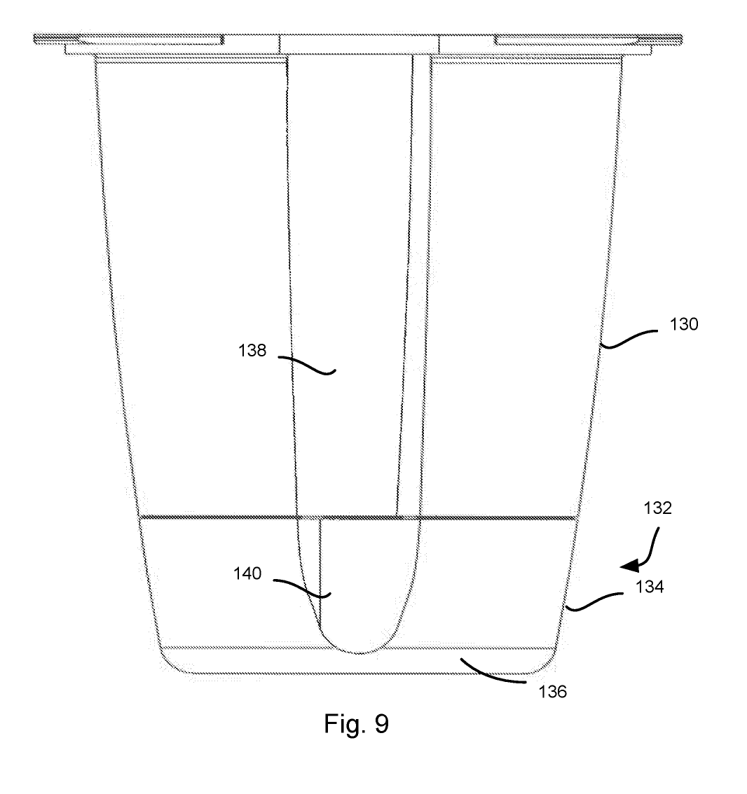

Referring to FIGS. 8 and 9, in the illustrated alternative embodiment, an upper ring 130 secures to a base cup 132. In this embodiment, the upper ring 130 may permanently secure to the base cup 132, such as by means of adhesive, sonic welding, or some other fastening means.

The base cup 132 defines a sidewall 134 fastened to the upper ring 130 and a bottom 136 spanning the bottom edge of the sidewall 134 to define the bottom of the cup defined by the combination of the base cup 132 and upper ring 130.

The upper ring 130 defines an upper tube portion 138 protruding from a lateral surface thereof. The base cup 134 further defines a lower tube portion 140 protruding from the sidewall 134 and aligned with the upper tube portion 138.

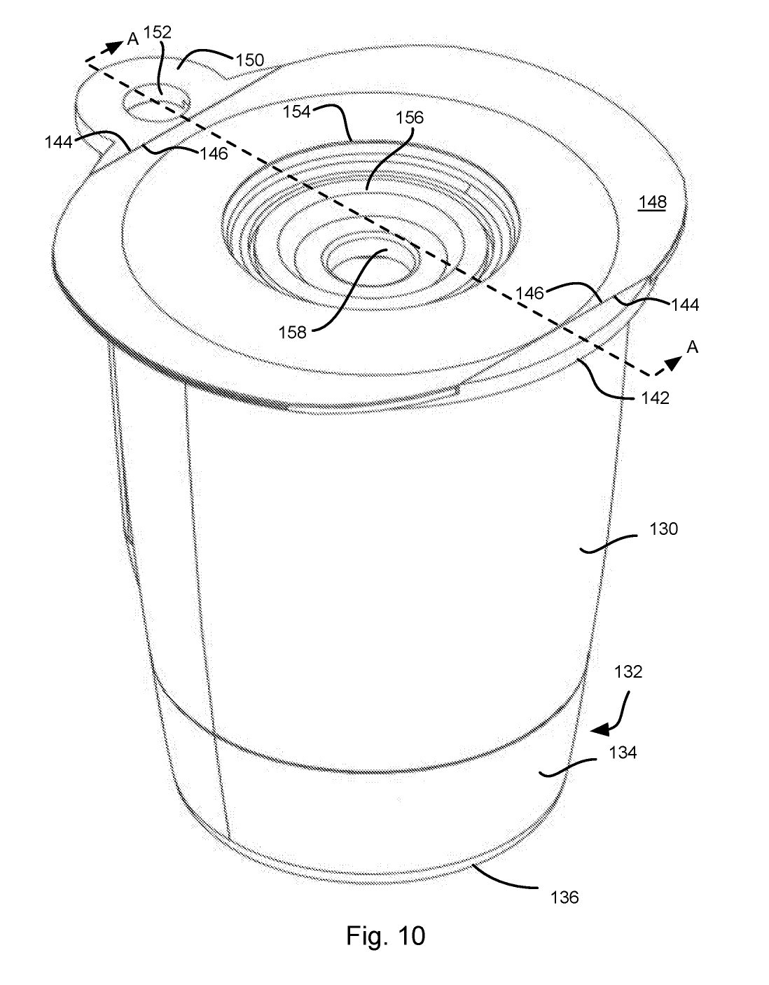

Referring to FIG. 10, in the illustrated embodiment, rim 142 projects outwardly from an upper edge of the ring 130. The rim 142 includes a pair of inward facing surfaces 144. The surfaces 144 are parallel to one another and oriented vertically. The surfaces 144 engage corresponding surfaces 146 formed on the edge of a lid 148 seated on the rim 142.

An upper surface of the lid 148 may be marked with taggant based inks or other indicia that are detectable by a beverage brewer in which the illustrated brewing cup is placed. In particular labeling on the lid 148 may be duplicated (e.g., on either side of the illustrated line AA or some other line of symmetry) such that the lid may be secured to the rim 142 in two positions. In this manner, damage to one instance of the labeling will not render the lid inoperable since another instance is available on the opposite side. In other embodiments, one side of the lid bears labeling triggering single-serving operation by a beverage brewer and another side bears labeling triggering multi-serving operation. In this manner by rotating the lid 180 degrees, the functions invoked by the beverage brewer may be changed. Because of the shape of the lid, e.g., the flattened areas 144, it may be secured to the ring 130 in only two positions corresponding to single-serving and multi-serving operation.

In some embodiments, the taggant-based inks are printed on a thin sheet of polypropylene, e.g., 10/1000 of an inch thick. This material is then inserted into the lid mold and the plastic of the lid 148 is injected around it, forming a one piece, fully vulcanized part.

The rim 142 may include a tab 150 defining an opening 152. The opening 152 may be in fluid communication with a channel defined by the upper tube portion 138. In use, an outlet probe 128 of a beverage brewer will insert into the opening 152 in the same manner as is shown in FIG. 7.

The lid 148 may define an opening 154 into which an insert 156 is inserted. The insert 156 may comprise a flexible and resilient polymer and define an opening 158 for receiving the inlet probe 102 of a beverage brewer in the same manner as is shown in FIG. 7. The flexible and resilient material of the insert 156 enables the creation of a seal with respect to the inlet probe 102.

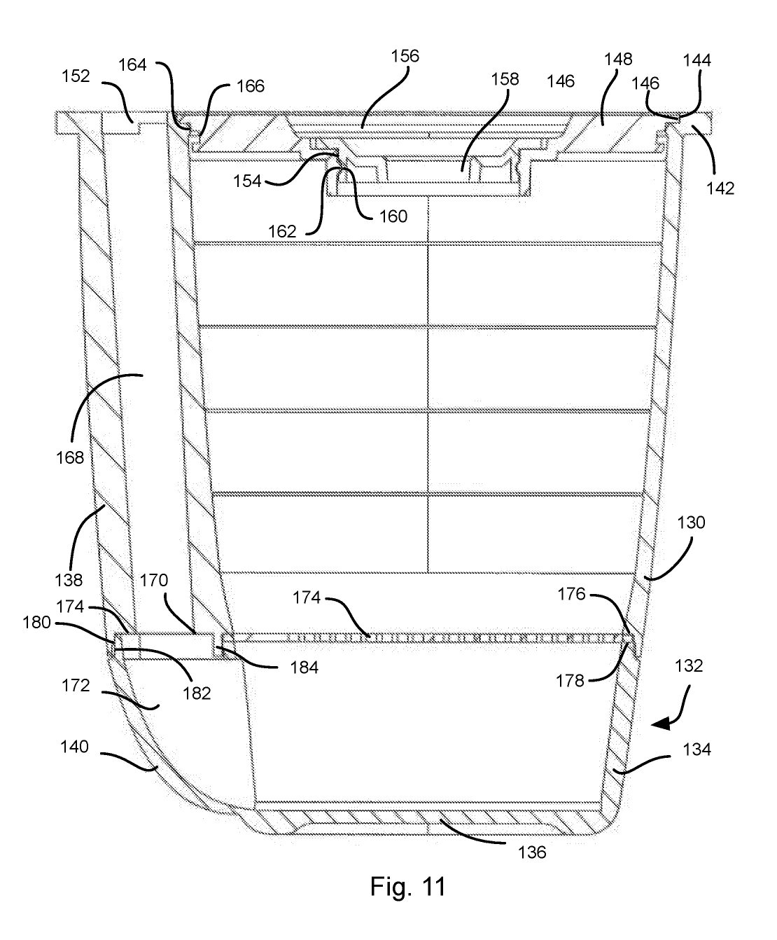

FIG. 11 illustrates a cross sectional view of the embodiment of FIGS. 8 through 10 that is sectioned along line AA. In the illustrated embodiment, the insert 156 may define a groove 160 receiving a ridge 162 encircling the opening 154 thereby retaining the insert 156 within the opening 154. As is apparent, the insert 156 is concave and defines a cavity for receiving the shoulder 120 surrounding an inlet probe 102 (see FIG. 7) and creating a seal. Sealing may also be promoted by snug engagement of the inlet probe 102 with the opening 158.

The lid 148 may snap into engagement with the ring 130. For example, the ring 130 may define an inward ridge 164 that engages a groove 166 formed on a circumferential surface of the lid 148.

As shown in FIG. 11, the upper tube portion 138 defines a channel 168 extending from the opening 152 to a lower opening 170 and that is separate from the central volume defined by the ring 130. The lower tube portion 140 defines a channel 172 that is positioned to align with the opening 170. In the illustrated embodiment, the channel 172 is a portion of the volume defined by the base cup 132 that protrudes outwardly form the inner surface of the sidewall 134 in order to connect the volume defined by the base cup 132 to the opening 170.

A screen 174 secures between the ring 130 and the sidewall 134 of the base cup 130 in order to prevent brewing media from being drawn up through the channel 168. In the illustrated embodiment, the screen 174 is positioned between a downward facing surface 176 defined near the lower edge of the ring 130 and an upward facing surface 178 defined at the upper edge of the sidewall 134 of the base cup 132. Accordingly, when the ring 130 is secured to the base cup 130, such as by sonic welding, the screen 174 will be securely fastened.

In the illustrated embodiment, the ring 130 defines a recess 180 that seats around a corresponding recess 182 defined by the sidewall 134. A sonic welding joint between the ring 130 and sidewall 132 may occur at the interface between the recesses 180, 182. In the illustrated embodiment, a portion 184 of the ring 130 projects downwardly between the screen 172 and the channel 172 such that there is no fluid path from the volume within the ring 130 to the channel 172 other than through the screen 174.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for manufacturing a cup comprising:
providing a base cup defining a bottom and a base sidewall extending upwardly from the bottom;
providing a first ring cup defining a first sidewall and an upper tube extending along an outer surface of the upper sidewall, the upper tube defining an upper opening and a lower opening;
providing a screen;
fastening the base cup to the first ring together and fastening the screen to at least one of the base cup and the first ring such that only fluid draining through the screen will be incident on the lower opening when the base cup, first ring, and screen are used in a brewing machine.

2. The method of claim 1, wherein securing the screen to the at least one of the base cup and the first ring comprises capturing the screen between the base cup and the first ring.

3. The method of claim 1, wherein the base cup further comprises a lower tube portion projecting outwardly from an inner surface of the base sidewall, the lower tube portion defining a channel aligned with the lower opening.

4. The method of claim 1, wherein fastening the base cup to the first ring comprises sonically welding the base cup to the upper cup.

5. The method of claim 1, wherein the base cup defines an outlet probe receptacle protruding inwardly from the bottom, the method further comprising:
placing a first quantity of a brewing substance in the first ring and base cup;
securing a first lid to the first ring, the first lid defining a first inlet probe aperture;
inserting the first ring and base cup into a first cavity of a first beverage brewer;
inserting a first inlet probe of the first beverage brewer into the first inlet probe aperture;
brewing a first beverage by inputting liquid through the first inlet probe and drawing liquid out through the first outlet probe;
removing the base cup from the first ring;
removably fastening the base cup to a second ring, the second ring extending upwardly from the base cup a different extent than the first ring;
placing a second quantity of the brewing substance in the second ring and base cup;
securing a second lid to the second ring, the second ring defining a second inlet probe aperture;
inserting the second ring and base cup into a second cavity of a second beverage brewer, the second beverage brewer including a second outlet probe and having a second outlet probe of the second coffee maker projecting into the outlet probe receptacle;
inserting a second inlet probe of the second beverage brewer into the second inlet probe aperture; and
brewing a second beverage by inputting liquid through the second inlet probe and drawing liquid out through a second outlet probe.

6. The method of claim 5, wherein the second ring extends upwardly from the base cup a smaller extent than the first ring.

7. The method of claim 6, wherein the second ring and base cup when fastened to one another define a volume sized for brewing of a single serving; and
wherein the first ring and base cup when fastened to one another define a volume sized for brewing three or more servings.

8. The method of claim 5, further comprising inserting the first outlet probe into the upper opening.

9. The method of claim 8, wherein the upper tube extends downwardly beyond a lowermost edge of the first ring.

10. The method of claim 8, wherein the tube defines a bottom opening, the bottom opening positioned outside of an interior volume defined by the base cup and second ring.

11. The method of claim 5, wherein the base cup includes base threads, the first ring includes first threads, and the second ring includes second threads;
wherein fastening the first ring to the base cup comprises engaging the base threads with the first threads; and
wherein fastening the second ring to the base cup comprises engaging the base threads with the second threads.

12. The method of claim 5, wherein the outlet probe receptacle is a first outlet probe receptacle, the base cup further defining a second outlet probe receptacle, the first and second outlet probe receptacles being 180 degrees apart.

13. The method of claim 5, wherein the outlet probe receptacle defines a continuous imperforated surface.

14. The method of claim 5, further wherein the first lid further comprises a resilient material and defines a recess on an upper surface of the first lid surrounding the first inlet probe aperture, the recess sized to receive a shoulder surrounding the first inlet probe.

15. A beverage brewing device for use with both a beverage brewer, the beverage brewing device comprising:
a base cup defining a bottom and a base sidewall extending upwardly from the bottom;
a first ring cup defining a first sidewall and an upper tube extending along an outer surface of the upper sidewall, the upper tube defining an upper opening and a lower opening; and
a screen;
wherein the base cup is fastened to the first ring and the screen is fastened to at least one of the base cup and the first ring such that only fluid draining through the screen will be incident on the lower opening when the base cup, first ring, and screen are used in the beverage brewer.

16. The beverage brewing device of claim 15, wherein the screen is at least partially secured to the base cup and first ring by being clamped between a lower edge of the first ring and an upper edge of the base cup.

17. The beverage brewing device of claim 15, wherein the base cup further comprises a lower tube portion projecting outwardly from an inner surface of the base sidewall, the lower tube portion defining a channel aligned with the lower opening.

18. The beverage brewing device of claim 1, wherein the base cup is sonically welded to the upper cup.

19. The beverage brewing device of claim 1, further comprising a lid removably secured to the first ring.

20. The beverage brewing device of claim 19, wherein the lid defines an opening and comprises an insert including a resilient material secured within the opening, the insert defining a recess, the recess sized to receive a shoulder surrounding an inlet probe of the beverage brewer effective to create a seal.
